(19) United States
(12) Patent Application Publication
(10) Pub. No.: US 2015/0163373 A1
(43) Pub. Date: Jun. 11, 2015

(54) DATA PROCESS SYSTEM, DATA PROCESS APPARATUS, AND DATA PROCESS METHOD

(71) Applicant: Nobuya MONDEN, Kanagawa (JP)

(72) Inventor: Nobuya MONDEN, Kanagawa (JP)

(73) Assignee: RICOH COMPANY, LTD., Tokyo (JP)

(21) Appl. No.: 14/555,866

(22) Filed: Nov. 28, 2014

(30) Foreign Application Priority Data
Dec. 5, 2013 (JP) 2013-252223

(51) Int. Cl. H04N 1/32; H04N 1/00

(52) U.S. Cl. CPC H04N 1/32667; H04N 1/00395; H04N 1/00477; H04N 1/32657; H04N 2201/0094

(57) ABSTRACT

A data process apparatus includes a read-out unit configured to read out screen data according to an error that has occurred in which the screen data includes information pertaining to the error, an obtaining unit configured to obtain a user interface component for receiving an operation for executing a solution procedure for solving the error, and a generating unit configured to generate a screen to be displayed according to the error by incorporating the user interface component in the screen data.

### BACKGROUND OF THE INVENTION

1. Field of the Invention

The present invention relates to a data process system, a data process apparatus, and a data process method.

2. Description of the Related Art

Conventionally, an image process apparatus such as an MFP (Multifunction Peripheral) is equipped with a help function. Accordingly, in a case where an error occurs, information pertaining to the error (e.g., procedural information, reference information) can be displayed on a help screen.

Various methods for displaying the help screen have been proposed. For example, Japanese Laid-Open Patent Publication No. 2007-206999 discloses a method of dynamically generating a help screen that is suitable for the user, so that the help screen can be more easily understood.

However, with the conventional image process apparatus, the user is required to solve an error by understanding the content displayed on the help screen (error solving procedure) and performing an operation according the displayed content. Therefore, even if the help screen displays contents that can easily be understood by the user, this does not reduce the workload of performing an operation for solving the error.

### SUMMARY OF THE INVENTION

The present invention may provide a data process system, a data process apparatus, and a data process method that substantially obviates one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a data process system, a data process apparatus, and a data process method particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a data process apparatus including a read-out unit configured to read out screen data according to an error that has occurred in which the screen data includes information pertaining to the error, an obtaining unit configured to obtain a user interface component for receiving an operation for executing a solution procedure for solving the error, and a generating unit configured to generate a screen to be displayed according to the error by incorporating the user interface component in the screen data.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating an example of an image process system including an image process apparatus and a mobile terminal that remotely controls the image process apparatus according to an embodiment of the present invention;

FIG. 2 is a schematic diagram illustrating a hardware configuration of an image process apparatus including an operation unit and a main body unit according to an embodiment of the present invention;

FIG. 3 is a schematic diagram illustrating hierarchical structures of program groups included in an operation unit and a main body unit of an image process apparatus according to an embodiment of the present invention;

FIG. 4 is a schematic diagram illustrating a hardware configuration of a mobile terminal according to an embodiment of the present invention;

FIG. 5 is a functional diagram of a help function of the various functions implemented by a program group of an image process apparatus and a remote application installed in a mobile terminal according to an embodiment of the present invention;

FIG. 6 is an operation data management table according to an embodiment of the present invention;

FIG. 7 is an example of a help data management table according to an embodiment of the present invention;

FIG. 8 is a sequence diagram illustrating the flow of a help screen display operation of an image process system according to an embodiment of the present invention;

FIG. 9 is a sequence diagram illustrating the flow of an error solve operation of an image process system according to an embodiment of the present invention;

FIG. 10 is a schematic diagram illustrating a detailed configuration of an operation data management unit for implementing a help function according to an embodiment of the present invention;

FIG. 11 is a schematic diagram illustrating an example of a help screen displayed in a help screen display operation according to an embodiment of the present invention; and

FIG. 12 is a schematic diagram illustrating a detailed configuration of an operation data management unit for implementing a help function according to another embodiment of the present invention.

### DETAILED DESCRIPTION OF THE PREFERRED EMBODIMENTS

Embodiments of the present invention are described with reference to the accompanying drawings. Like components are denoted with like reference numerals throughout the description and drawings.

### First Embodiment

### <Entire Configuration of Image Process System>

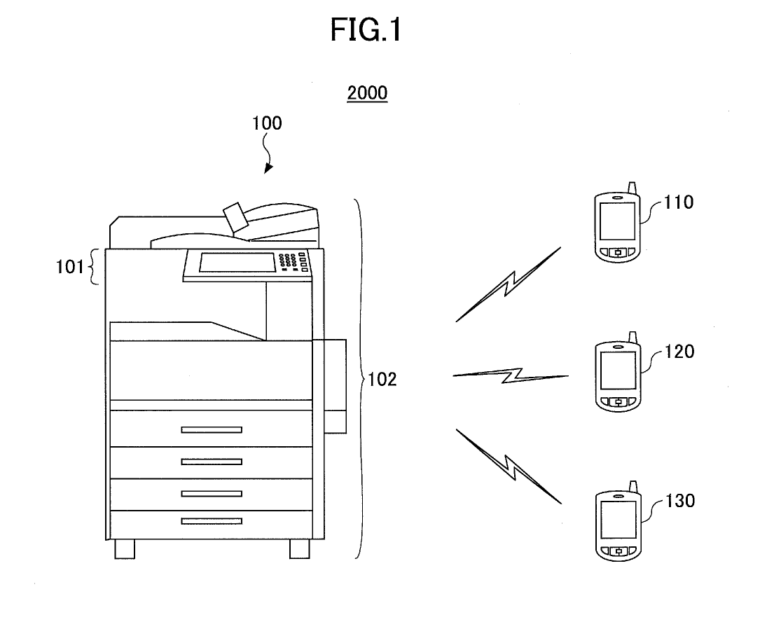

First, an entire configuration of an image process system including a mobile terminal (first data process apparatus) and an image process apparatus (second data process apparatus) according to an embodiment of the present invention is described. FIG. 1 is a schematic diagram illustrating an entire configuration of an image process system 2000 including an image process apparatus 100 and mobile terminals 110-130 according to an embodiment of the present invention.

In FIG. 1, the image process apparatus 100 is an MFP (Multifunction Peripheral) that includes, for example, a copy function, a scan function, a facsimile function, and a print function. The image process apparatus 100 also includes various functions related to an image process function (e.g., help function).

As illustrated in FIG. 1, the image process apparatus 100 includes an operation unit 101 and a main body unit 102.

The operation unit 101 is used for allowing a user to perform various operations such as selecting an image process function to be executed by the main body part 102, inputting various setting values for executing an image process function, inputting an instruction for executing an image process function, and switching the displaying of screens.

The mobile terminals 110-130 function as an operation unit of the image process apparatus 100, respectively. Each of the mobile terminals 110-130 is configured to control the image process apparatus 100 from a location that is remote from the image process apparatus 100 (i.e., remote operation). In a case where an error occurs in the image process apparatus 100, each of the mobile terminals 110-130 is configured to display the below-described help/solve screen according to various operations by the user of the mobile terminal 110-130.

The mobile terminals 110-130 may include portable data terminals such as PCs (personal computers), tablet terminals, smart phones, mobile phones, and PDAs (Personal Digital Assistants). For the sake of convenience, FIG. 1 illustrates three mobile terminals that function as operation units of the image process apparatus 100. However, the number of mobile terminals are not limited to that of the example illustrated in FIG. 1.

### <Hardware Configuration of Image Process Apparatus>

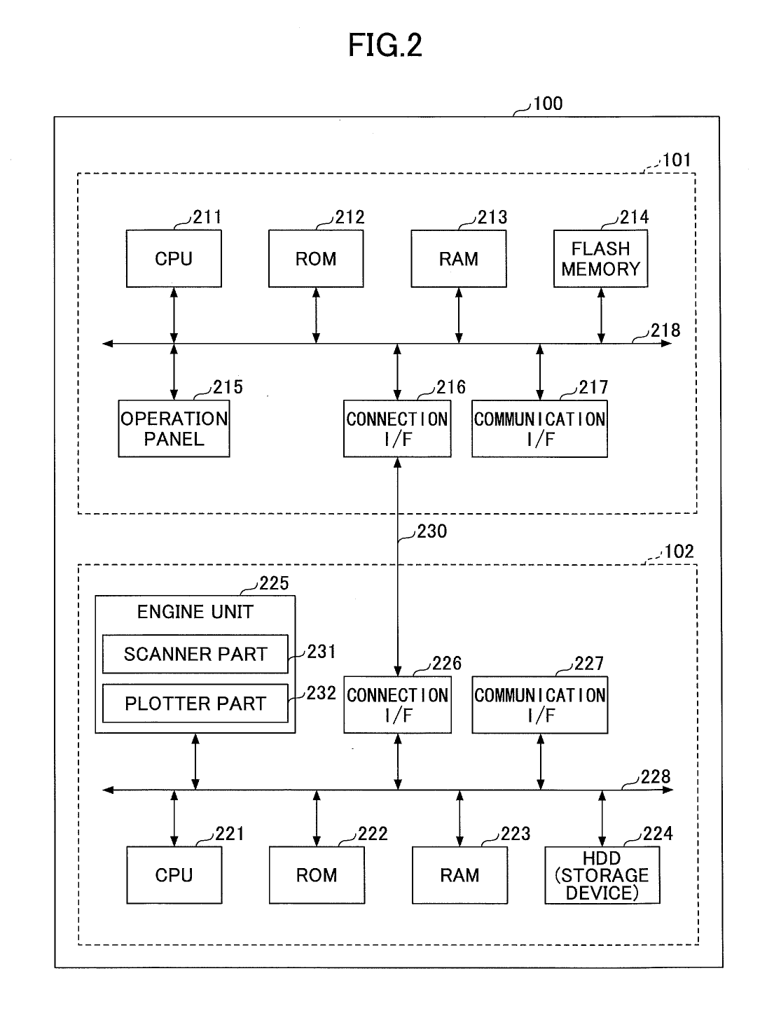

Next, a hardware configuration of the image process apparatus 100 is described. FIG. 2 is a schematic diagram illustrating a hardware configuration of the image process apparatus 100 according to an embodiment of the present invention.

As illustrated in FIG. 2, the operation unit 101 of the image process apparatus 100 includes, for example, a computer including a CPU (Central Processing Unit) 211, a ROM (Read-Only Memory) 212, a RAM (Random Access Memory) 213, a flash memory 214, an operation panel 215, a connection I/F (interface) 216, and a communication I/F 217. The elements included in the operation unit 101 are connected to each other by a bus 218.

The CPU 211 controls the entire operation unit 101 by using the RAM 213 as a work area to execute various programs stored in the ROM 212 or the flash memory 214.

The flash memory 214 is a non-volatile medium that stores various programs executed by the CPU 211 and various data.

The operation panel 215 is used for allowing the user to perform various operations thereon. Further, the operation panel 215 displays an internal status of the image process apparatus 100.

The connection I/F 216 is an interface for communicating with the main body unit 102 via a communication path 230, In this embodiment, a USB (Universal Serial Bus) standard interface is used as the connection I/F 216.

The communication I/F 217 is an interface for communicating with the mobile terminals 110-130.

Similarly, the main body unit 102 of the image process apparatus 100 includes, for example, a computer including a CPU (221), a ROM 222, a RAM 223, a storage device (e.g., HDD (Hard Disk Drive)) 224, an engine unit 225, a connection I/F 226, and a communication I/F 227. The elements included in the main body unit 102 are connected to each other by a bus 228.

The CPU 221 controls the entire operation unit 101 by using the RAM 223 as a work area to execute various programs stored in the ROM 222 or the flash memory 224. In addition, the CPU 221 implements various functions including the below-described help function.

The storage device 224 is a non-volatile medium that stores various programs (including a program for implementing the help function) executed by the CPU 221 and various data.

The engine unit 225 is a hardware device for performing an information process for implementing the image process functions such as a copy function, a scan function, a facsimile function, and a print function. The engine unit 225 includes, for example, a scanner part 231 for reading (scanning) a document (manuscript copy) and a plotter part 232 for performing a printing process on a sheet material (e.g., paper). Further, the engine unit 225 may also include, for example, a communication part for performing facsimile communication, a finisher for sorting printed sheet material and an ADF (Automatic Document Feeder) for automatically feeding a document.

The connection I/F 226 is an interface for communicating with the operation unit 101 via the communication path 230. In this embodiment, a USB (Universal Serial Bus) standard interface is used as the connection I/F 226.

The communication I/F 227 is an interface for communicating with the mobile terminals 110-130. Alternatively, the mobile terminals 110-130 may be configured to communicate with the main body unit 102 by being connected to the communication I/F 217 of the operation unit 101. Alternatively, the mobile terminals 110-130 may be configured to communicate with the main body unit 102 by being directly connected to the communication I/F 227 of the main body unit 102.

### <Hierarchical Structure of Programs Included in the Operation Unit and the Main Body Unit of the Image Process Apparatus>

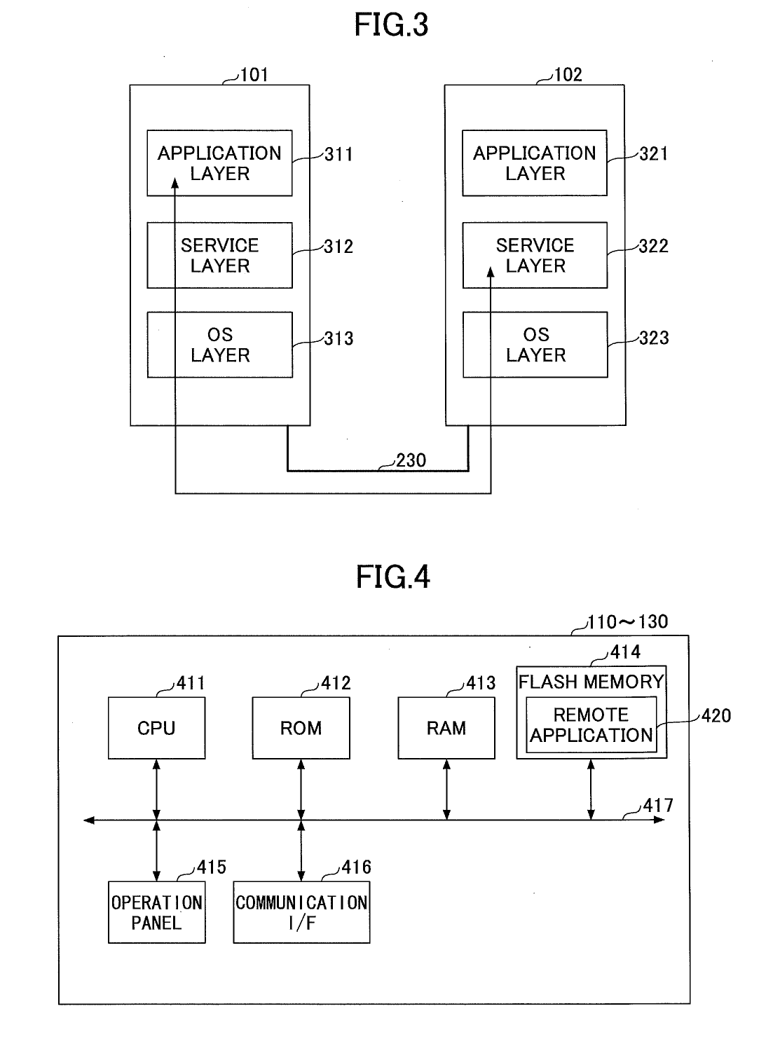

Next, the hierarchical structures of the program groups included in the operation unit 101 and the main body unit 102 of the image process apparatus 100 are described. FIG. 3 is a schematic diagram illustrating the hierarchical structures of the program groups included in the operation unit 101 (ROM 212, flash memory 214) and the main body unit 102 (ROM 222, storage device 224).

First, the hierarchical structure of the program group included in the main body unit 102 (ROM 222, storage device 224) is described. The program group included in the main body unit 102 can be broadly divided into an application layer 321, a service layer 322, and an OS layer 323. A program that is categorized to belong to the application layer 321 is a program for implementing an image process function by actuating a hardware resource. More specifically, the program belonging to the application layer 321 may be, for example, a copy application, a scan application, a facsimile application, or a print application.

A program that is categorized to belong to the service layer 322 is a program that intervenes between the application layer 321 and the OS layer 323. The program belonging to the service layer 322 functions as an interface for enabling the program of the application layer 321 to use a hardware resource of the main body unit 102 or reporting a status of a hardware resource of the main body unit 102.

More specifically, the program belonging to the service layer 322 may, for example, receive a request to actuate a hardware resource (actuation request) or arbitrate between multiply received actuation requests. Further, in a case where an error is detected in a hardware resource, the program belonging to the service layer 322 may transmit error information. The actuation request received by the program belonging to the service layer 322 includes a request for a hardware resource to perform a predetermined process such as a request for a scanner part 231 to perform reading (scanning) or a request for a plotter part 232 to perform printing.

It is to be noted that a program belonging to the application layer 311 of the operation unit 101 also has a function similar to the above-described interface function of the program belonging to the service layer 322. That is, the program belonging to the application layer 311 also implements an image process function by actuating a hardware resource of the main body unit 102 by accessing the service layer 322.

A program belonging to the OS layer 323 that is a program referred to as basic software provides a basic function for controlling a hardware resource of the main body unit 102. The program belonging to the service layer 322 receives a request for actuating a hardware resource (actuation request) from the program belonging to the application layer 321, converts the actuation request into a command that can be interpreted by the OS layer 323, and transmits the command to the OS layer 323. Then, the program belonging to the OS layer 323 executes the command for executing a data process for implementing an image process function in accordance with the actuation request to the hardware resource. Further, in a case where the program belonging to the OS layer 323 receives a signal indicating detection of an error in a hardware resource, the program belonging to the OS layer 323 reports the error as error information to the service layer 322.

Next, the hierarchical structure of the program group included in the operation unit 101 (ROM 212, flash memory 214) is described. Similar to the main body unit 102, the program group included in the operation unit 101 can be broadly divided into an application layer 311, a service layer 312, and an OS layer 313.

However, the functions of the program belonging to the application layer 311 and the kinds of actuation requests that can be received by the program belonging to the service layer 312 are different from those of the application and service layers 321, 322 of the main body unit 102. The program belonging to the application layer 311 of the operation unit 101 mainly provides a user interface function for executing various operations and displaying information.

In this embodiment, an OS (Operating System) used for the operation unit 101 and an OS used for the main body unit 102 operate independently. Further, as long as the operation unit 101 and the main body unit 102 can communicate with each other, different types of OSs may be used. For example, Android (registered trademark) may be used for the operation unit 101 whereas Linux (registered trademark) may be used for the main body unit 102.

Accordingly, because the operation unit 101 and the main body unit 102 are controlled by different Oss, communications between the operation unit 101 and the main body unit 102 are performed communications between different data process apparatuses rather than communications (processes) performed inside a single apparatus.

For example, in a case where the operation unit 101 receives an operation from a user, a command indicating the user's operation is transmitted from the operation unit 101 to the main body unit 102 (command communication). As another example, in a case of instructing the operation unit 101 to display a display screen, an event instructing the displaying of the display screen is transmitted from the main body unit 102 to the operation unit 101.

### <Hardware Configuration of the Mobile Terminal>

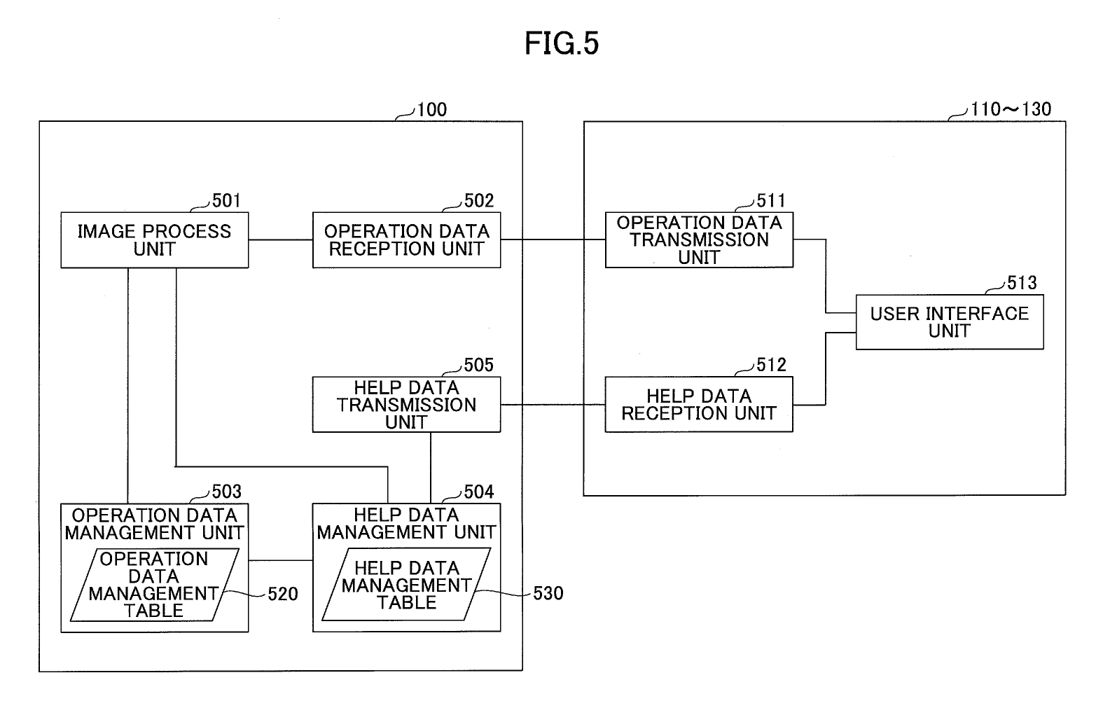

Next, hardware configurations of the mobile terminals 110-130 are described. In the following, the mobile terminals 110-130 are collectively referred to as “mobile terminal 110” for the sake of convenience. FIG. 4 is a schematic diagram illustrating a hardware configuration of the mobile terminal 110 according to an embodiment of the present invention.

As illustrated in FIG. 4, each of the mobile terminal 110 includes, for example, a computer including a CPU 411, a ROM 412, a RAM 413, a flash memory 414, an operation panel 415, and a communication I/F 416. The elements included in the mobile terminal 110 is connected to each other by a bus 417.

The CPU 411 controls the entire mobile terminal 110 by using the RAM 413 as a work area to execute various programs stored in the ROM 412 or the flash memory 414.

The flash memory 414 is a non-volatile medium that stores various programs executed by the CPU 411 and various data. The programs executed by the CPU 411 includes a program of the below-described remote application 420. The remote application 420 enables the mobile terminal 110 to function as an operation unit of the image process apparatus 100 and remotely control the image process apparatus 100.

The operation panel 415 displays an internal status of the mobile terminal 110. The operation panel 415 also displays a screen of an application (e.g., remote application 420) installed in the mobile terminal 110. Further, the operation panel 415 is used for allowing the user to perform various operations thereon.

The communication I/F 416 is an interface for communicating with the image process apparatus 100 by connecting to the communication I/F 217 of the operation unit 101 or the communication I/F 227 of the main body unit 102. Communications between the mobile terminal 110 and the image process apparatus 100 are implemented by using, for example, a wireless network (e.g., Wi-Fi). It is, however, to be noted that the communications are not limited to a particular standard. That is, communications may be implemented by an arbitrary standard.

### <Configuration of a Help Function>

Next, a configuration of a help function that is implemented by the program group of the main body part 102 and the remote application 420 of the mobile terminal 110 is described. The help function is one of the various functions that are implemented by the program group of the main body part 102 and the remote application 420 of the mobile terminal 110. FIG. 5 is a functional diagram of the help function of the various functions implemented by the program group of the image process apparatus 100 and the remote application installed in the mobile terminal 110 according to an embodiment of the present invention.

First, the configuration of the functions (function units) of the main body unit 102 for implementing the help function is described. As illustrated in FIG. 5, the main body unit 102 of the image process unit 100 has function units for implementing the help function including an image process unit 501, an operation data reception unit 502, an operation data management unit 503, a help data management unit 504, and a help data transmission unit 505.

The image process unit 501 controls the engine unit 225 that implements image process functions such as the copy function, the scan function, the facsimile function, and the print function. Further, in a case where, for example, an error (e.g., paper-jam) occurs in the scanner part 231 and the plotter part 232 of the engine unit 225 or a setting error occurs in the image process unit 501, the image process unit 501 detects the errors. Further, the image process unit 501 reports the detected error by transmitting error information to the operation data management unit 503.

The operation data reception unit 502 receives commands indicating various operations performed on the mobile terminal 110 and transmits the commands to the image process unit 501. The commands indicating the various operations includes various setting values for implementing the image process functions. The various setting values for implementing the image process functions are input to the mobile terminal 110 and received by the image process unit 501 via the operation data reception unit 502. By transmitting the setting values to the image process unit 501, the settings for implementing the image process functions can be set to the image process unit 501.

In a case where the operation data management unit 503 receives error information transmitted from the image process unit 501, the operation data management unit 503 derives multiple solution procedures for solving the error identified by the error information. Further, the operation data management unit 503 receives an operation to execute each of the derived solution procedures and identifies an error solution operation data for executing a solution procedure corresponding to the received operation. The operation data management unit 503 identifies the error solution operation data according to an operation data management table 520. The operation data management unit 503 also identifies a URI (Uniform Resource Identifier) associated with the identified error solution operation data according to the operation data management table 520. The URI associated with the error solution operation data indicates an execution target on which the solution procedure is to be performed.

The operation data management unit 503 transmits the error solution operation data including the identified URI to the help data management unit 504.

As described below, by incorporating (embedding) the error solution operation data in a help screen, the error solution operation data can be displayed as an operation button. In a case where a user operates the operation button, the error solution operation data serves as a request function for requesting the image process apparatus 100 to perform a solution operation on an execution target (URI). That is, the error solution operation data functions as a user interface component by being incorporated into the help screen.

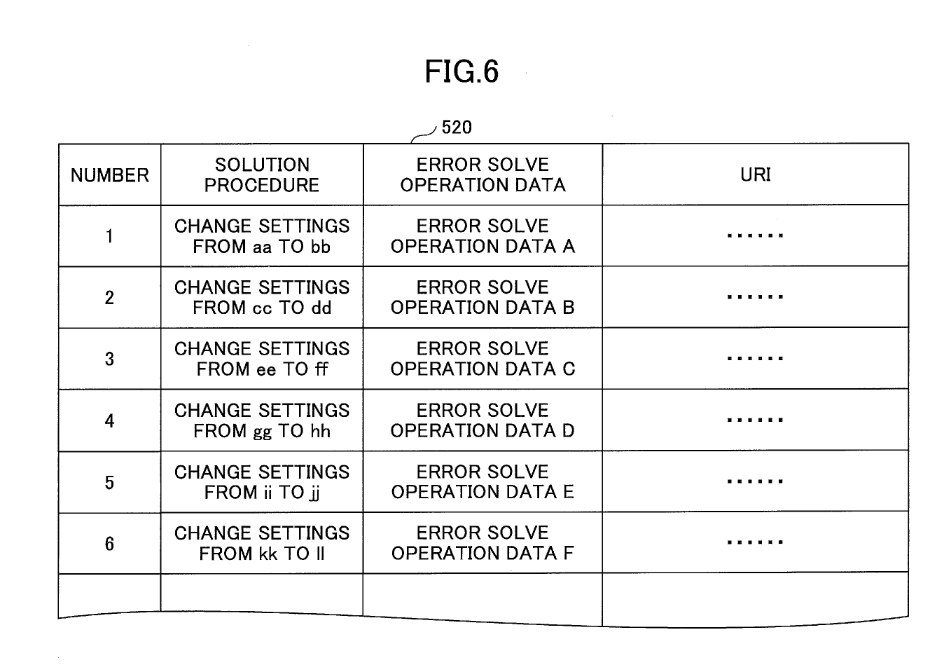

FIG. 6 illustrates an example of the operation data management table 520. As illustrated in FIG. 6, each solution procedure that is derived according to error information is registered in correspondence with error solution operation data in the operation data management table 520. The error solution operation data corresponds to a solution procedure that is to be executed in a case where an operation for executing the solution procedure is received. Further, a URI that indicates an execution target of a solution procedure is registered in correspondence with the error solution operation data. Therefore, in a case where the operation data management unit 503 receives error information from the image process unit 501, the operation data management unit 503 derives multiple solution procedures according to the received error information. Accordingly, error solution operation data and a URI corresponding to each of the solution procedures can be obtained.

In a case where an error occurs in the image process apparatus 100, the help data management unit 504 reads out a help screen corresponding to the error information pertaining to the error from a help data management table 530.

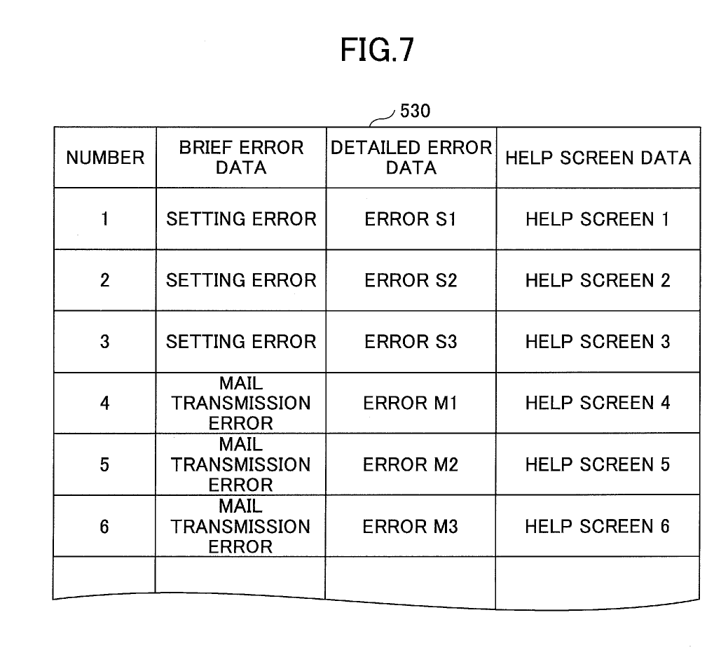

FIG. 7 illustrates an example of the help data management table 530. As illustrated in FIG. 7, each detailed error data that is included in the error information is registered in correspondence with help screen data in the help data management table 530. Therefore, in a case where the help data management unit 504 receives error information from the image process unit 501, the help data management unit 504 extracts the detailed error data included in the error information and reads out help screen data corresponding to the extracted detailed error data from the help data management table 530.

Further, the help data management unit 504 generates a help/solve screen by incorporating the error solution operation data (along with a URI) obtained from the operation data management unit 503 in the screen data that is read out from the help data management table 530.

The help data transmission unit 505 transmits the generated help/solve screen to the mobile terminals 110-130. In this embodiment, the help data transmission unit 505 transmits the help/solve screen to the mobile terminals 110-130 via a wireless network (e.g., Wi-Fi).

Next, the configuration of the functions (function units) of the mobile terminal 110 for implementing the help function is described. The mobile terminal 110 implements the help function as a function of the remote application 420.

As illustrated in FIG. 5, the mobile terminal 110 has function units including an operation data transmission unit 511, a help data reception unit 512, and a user interface unit 513.

In a case where the user interface unit 513 recognizes a user's operation performed on the operation panel 515 of the mobile terminal 110, the operation data transmission unit 511 converts the user's operation into a predetermined command and transmits the command to the image process apparatus 100. In a case where a setting value for implementing an image process function is input to the mobile terminal 110 by way of a screen displaying the remote application 420, the setting value is transmitted to the operation data reception unit 502 via the operation data transmission unit 511.

The help data reception unit 512 receives the help/solve screen transmitted from the help data transmission unit 505 of the image process apparatus 100. Further, the help data reception unit 512 transmits the received help/solve screen to the user interface unit 513.

The user interface unit 513 displays, for example, the screen of the remote application 420 and the help/solve screen. The user interface unit 513 also recognizes various operations performed on the operation panel 415 by the user and transmits the operations to the operation data transmission unit 511.

### <Processes of the Image Process System>

Next, various processes performed in the image process system 2000 for implementing the help function is described. The following processes are performed in the image process system 2000 for implementing the help function.

help/solve screen displaying process

error solving process

### <Flow of the Help/Solve Screen Displaying Process>

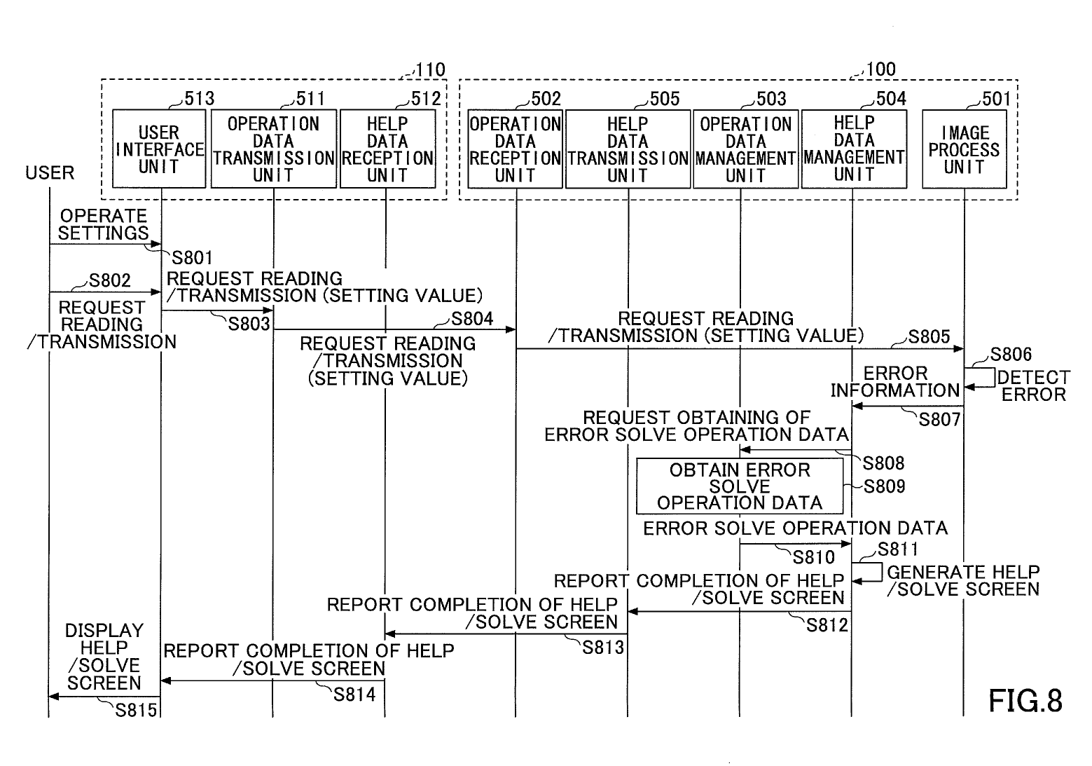

First, the flow of the help/solve screen displaying process is described. FIG. 8 is a sequence diagram illustrating the flow of the help/solve screen displaying process performed in the image process system 2000.

For the sake of convenience, FIG. 8 illustrates a case where an error in the image process apparatus 100 occurs in response to an operation performed on the mobile terminal 110, and a help/solve screen being displayed on the mobile terminal 110. This case may, however, apply to a case where the operation is performed on the mobile terminal 120 or the mobile terminal 130.

Although FIG. 8 illustrates a case where the error occurs in response to a user's operation pertaining to a facsimile function of the image process apparatus 100, the same applies to a case where the user performs an operation pertaining to another function. Although FIG. 8 illustrates a case where the error occurs in response to a setting operation performed by the user, the same applies to a case where the user performs an operation other than the setting operation.

As illustrated in FIG. 8, the user activates the remote application 420 to display a facsimile setting screen by operating the operation panel 415. After the facsimile setting screen has been displayed, the user performs a setting operation pertaining to a facsimile function. When the user performs the setting operation, the user interface unit 513 recognizes the setting operation (Step S801).

After the user completes the setting operation pertaining to the facsimile function, the user inputs an instruction to execute the facsimile function. The user interface unit 513 recognizes (interprets) the input instruction as a request to read a document (manuscript copy) and transmit the data read from the document (reading/transmission request) (Step S802).

Then, the user interface unit 513 adds a setting value of the recognized setting operation of Step S801 into the reading/transmission request and transmits the reading/transmission request to the operation data transmission unit 511 (Step S803).

Then, the operation data transmission unit 511 transmits the reading/transmission request to the operation data reception unit 502 of the image process apparatus 100 (Step S804). Then, the operation data reception unit 502 transmits the reading/transmission request to the image process unit 501 (Step S805).

Then, the image process unit 501 sets the setting value included in the reading/transmission request. In this example, it is supposed that the setting value included in the reading/transmission request is a setting value that cannot be set by the image process unit 501.

In this case, the image process unit 501 detects an error (Step S806) and transmits error information to the help data management unit 504. Then, the help data management unit 504 receives the error information (Step S807) and transmits a request to the operation data management unit 503 for obtaining error solve operation data (error solve operation data obtain request) (Step S808). The error information is included in the error solve operation data obtain request transmitted to the operation data management unit 503.

Then, the operation data management unit 503 obtains error solve operation data (including URI) according to the error information included in the transmitted error solve operation data obtain request and the operation data management table 520 (error solve data obtaining process) (Step S809). The error solve data obtaining process performed by the operation data management unit 503 is described in detail below.

Then, the operation data management unit 503 transmits the obtained error solve operation data (including URI) to the help data management unit 504 (Step S810). The help data management unit 504 refers to the help data management table 530 based on the error information received in Step S807 and reads out a help screen according to the error information. Further, the help data management unit 504 generates a help/solve screen by incorporating the error solve operation data (including URI) received in Step S810 into the read out help screen (Step S811). Then, the help data management unit 504 adds the generated help/solve screen into a help/solve screen completion report and transmits the help/solve screen completion report to the help data transmission unit 505 (Step S812).

Then, the help data transmission unit 505 transmits the received help/solve screen completion report to the help data reception unit 512 of the mobile terminal (Step S813). Then, the help data reception unit 512 transmits the help/solve screen completion report to the user interface unit 513 (Step S814).

Then, the user interface unit 513 displays the help/solve screen included in the help/solve screen completion report (Step S815). Thereby, the user can recognize that an error has occurred due to the setting value that was input in the setting operation of Step S801.

### <Flow of Solving an Error>

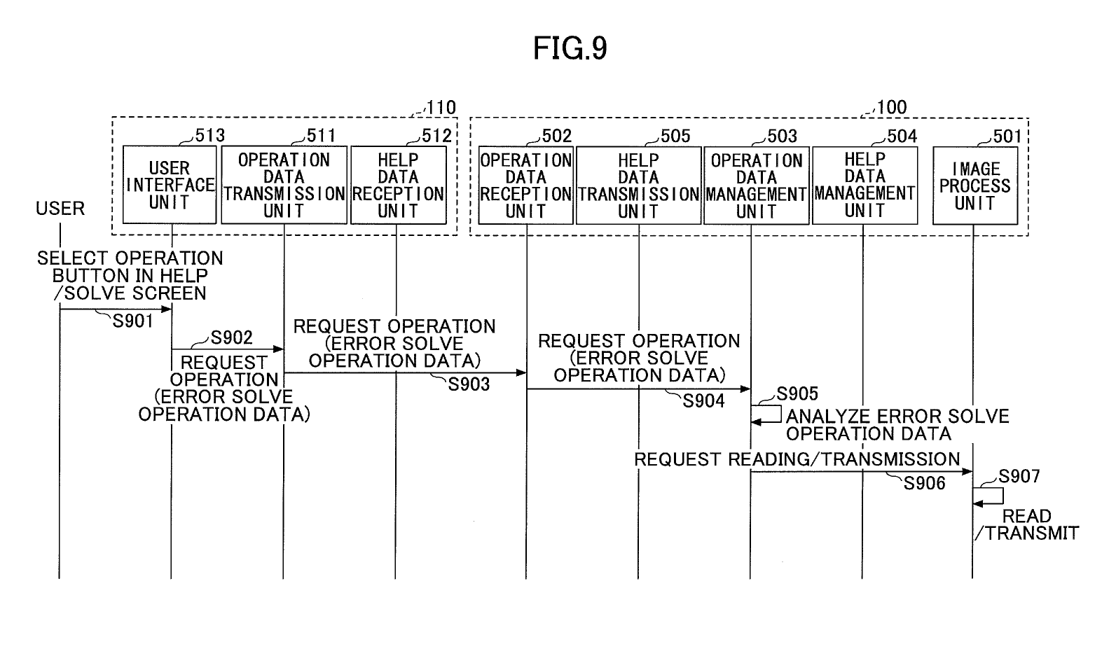

Next, the flow of solving an error in an image process system is described. FIG. 9 is a sequence diagram illustrating the flow of an operation for solving an error in an image process system. In a case where the help/solve screen is displayed in the mobile terminal 110 in Step S815, an error solving operation of FIG. 9 is initiated when the user presses an operation button corresponding to the error solve operation data (URI) incorporated in the help screen

When the operation button in the help/solve screen is selected by the user (Step S901), the user interface unit 513 recognizes the selection of the user and transmits an operation request to the operation data transmission unit 511 (Step S902). It is to be noted that the error solve operation data (URI) is included in the operation request transmitted to the operation data transmission unit 511.

When the operation data transmission unit 511 receives the operation request from the user interface unit 513, the operation data transmission unit 511 transmits the operation request to the operation data reception unit 502 of the image process apparatus 100 (Step S903). When the operation data reception unit 502 receives the operation request from the operation data transmission unit 511, the operation data reception unit 502 transmits the operation request to the operation data management unit 503 (Step S904).

Then, the operation data management unit 503 extracts a setting value to be changed by analyzing the error solve operation data (URI) included in the operation request from the operation data reception unit 502 (Step S905). Then, the operation data management unit 503 transmits a reading/transmission request to the image process unit 501 (Step S906). The extracted setting value is included in the reading/transmission request transmitted to the image process unit 501.

When the image process unit 501 receives the reading/transmission request, the image process unit 501 extracts the setting value included in the reading/transmission request and performs a reading/transmission process (i.e., facsimile transmission) according to the extracted setting value (Step S907).

Thereby, even in a case where an error occurs, the user can solve the error by selecting the operation button displayed on the help/solve screen, so that a desired image process function (facsimile function in the example of FIG. 9) may proceed. That is, unlike the related art example, the user can be alleviated from the task of understanding the contents displayed on the help screen and performing an appropriate operation based on the displayed contents, in order to solve an error and have a desired image process function executed.

As a result, the operation workload of the user can be reduced in a case where an error occurs.

### <Flow of the Error Solve Data Obtaining Process of the Operation Data Management Unit>

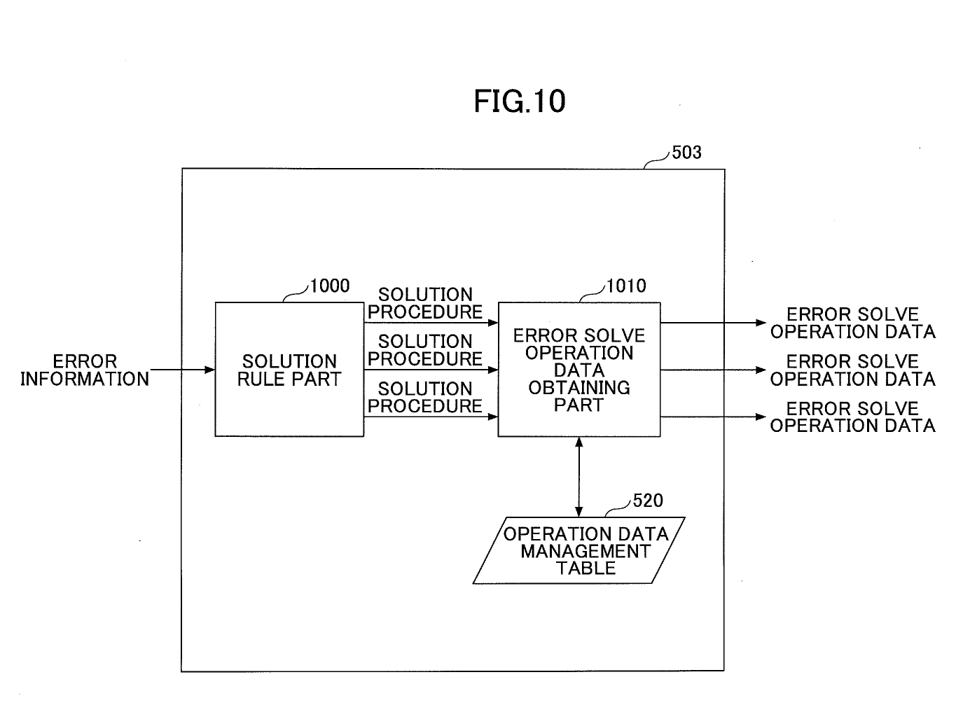

Next, the flow of the error solve data obtaining process (Step S809) performed by the operation data management unit 503 of the image process apparatus 100 is described. FIG. 10 is a schematic diagram illustrating the flow of the error solve data obtaining process (Step S809) performed by the operation data management unit 503.

As illustrated in FIG. 10, the operation data management unit 503 includes a solution rule part 1000. The solution rule part 1000 include rules for deriving multiple operation procedures (solution procedures) for solving an error when error information is input to the operation data management unit 503.

The solution procedures derived by the solution rule part 1000 according to the error information are input to the error solve operation data obtaining unit 1010. The error solve operation data obtaining unit 1010 refers to the operation data management table 520 and obtains error solve operation data according to the input solution procedures.

As described above, error solve operation data and a URI are registered in the operation data management table 520 in correspondence with each solution procedure. Therefore, error solve operation data (including URI) corresponding to a solution procedure can be obtained according to the operation data management table 520.

### <Description of the Help/Solve Screen>

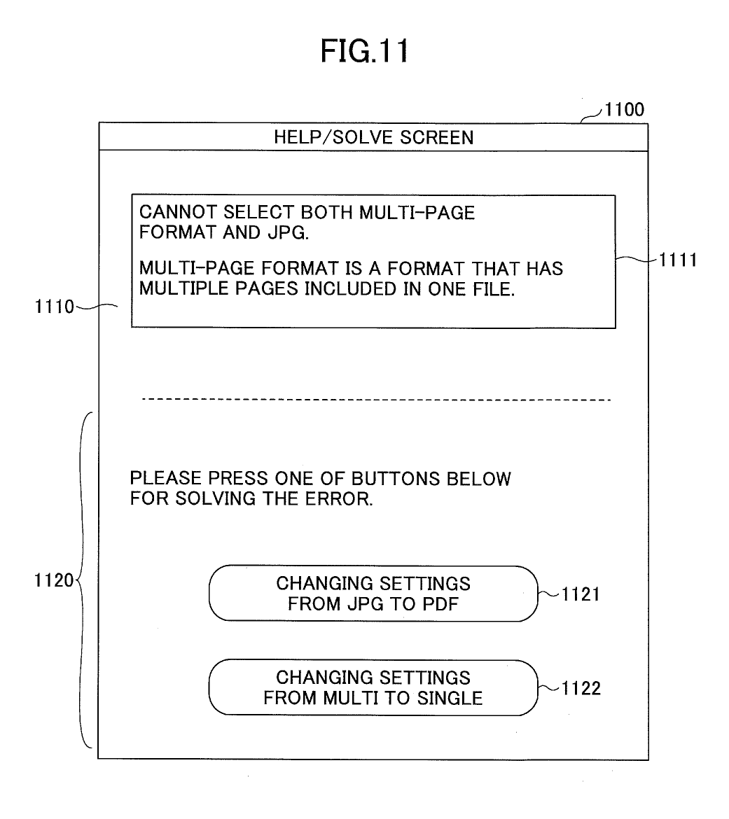

Next, the help/solve screen that is generated by the help data management unit 504 by executing the help/solve screen displaying process is described. FIG. 11 illustrates an example of the help/solve screen generated by the help data management unit 504.

As illustrated in FIG. 11, the help/solve screen 1100 includes a help screen 1110 that is managed by the help data management unit 504 and operation buttons 1121, 1122 that correspond to the error solve operation data (URI) incorporated in the help screen 1110.

Information 1111 pertaining to an error that has occurred is displayed in the help screen 1110. The operation buttons 1121, 1122 are displayed in an incorporation area 1120 of the help screen 110.

The example of FIG. 11 illustrates a case where a setting error has occurred due to “multi-page format” and “jpg” being simultaneously selected by the user. In order to solve the setting error, there are a solution procedure of changing the settings from “jpg” to “pdf” and a solution procedure of changing the settings from “multi-page format” to “single page format”.

Accordingly, error solve operation data corresponding to each of the solution procedures are incorporated in the help screen 1110. As a result, the operation button 1121 indicating “change the settings from jpg to pdf” and the operation button 1122 indicating “change the settings from multi to single” are displayed in the help/solve screen 1100.

Accordingly, the user can solve the error and have the facsimile function executed by selecting (pressing) the operation button 1121 or the operation button 1122 displayed in the incorporation area 1120.

With the above-described embodiment of the present invention, the help screens can be managed in correspondence with each detailed error information included in the error information. Further, an operation corresponding to each solution procedure for solving an error can be received. Further, error solve operation data for performing the solution procedure and a URI indicating an execution target on which the solution procedure is to be performed can be managed in correspondence with each solution procedure. Further, a solution procedure(s) corresponding to an error can be derived according to solution rules. Further, in a case where an error occurs, a help/solve screen can be generated by incorporating error solve operation data (corresponding to a solution procedure derived according to the solution rules) in a help screen corresponding to the error.

Accordingly, the user can solve an error and have a desired image process function executed by selecting (pressing) an operation button corresponding to an error solve operation data incorporated in a help/solve screen. That is, unlike the related art example, the user can be alleviated from the task of understanding the contents displayed on the help screen and performing an appropriate operation based on the displayed contents, in order to solve an error and have a desired image process function executed.

As a result, the operation workload of the user can be reduced in a case where an error occurs.

### Second Embodiment

In the first embodiment, in a case where multiple solution procedures are derived from the solution rule based on error information, error solution operation data corresponding to each of the multiple solution procedures are incorporated in the help screen 1110. However, as described in the following second embodiment, a single error solution operation data can be selected from multiple error solution operation data corresponding to the multiple solution procedures and incorporated in the help screen 1110.

### <Flow of the Error Solve Operation Data Obtaining Process of the Operation Data Management Unit>

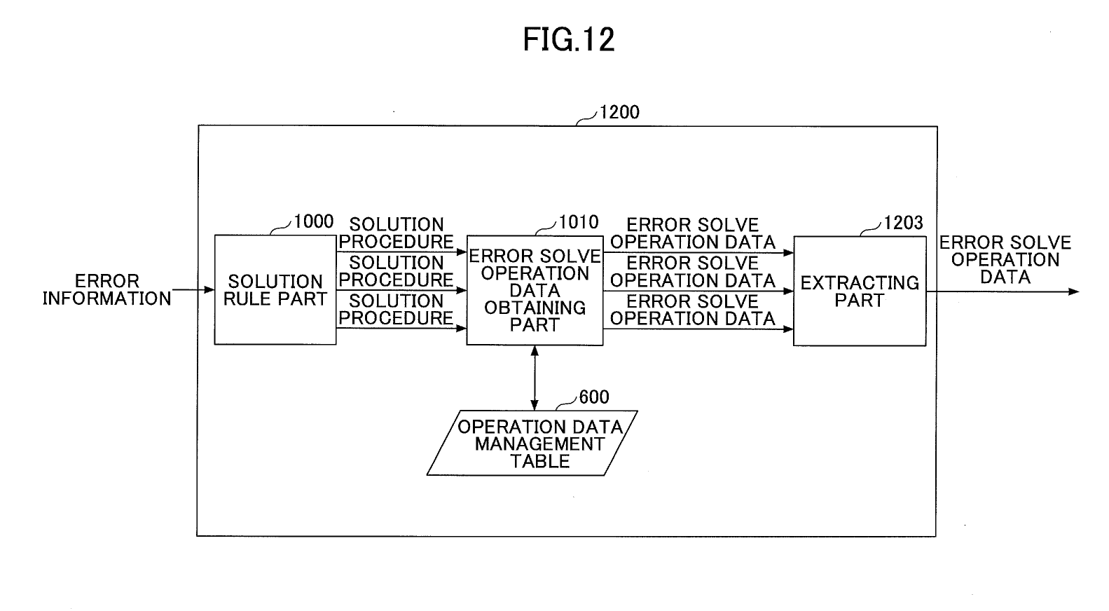

FIG. 12 is a schematic diagram illustrating the flow of the error solve data obtaining process performed by an operation data management unit 1200 of the image process apparatus 100.

The main difference of the error solve data obtaining process of FIG. 10 and the error solve data obtaining process of FIG. 12 is that an extracting part 1203 is included in the operation data management unit 1200. The extracting part 1203 extracts a single error solve operation data (including URI) from multiple error solve operation data (including URI) that are obtained according to the operation data management table 520 in correspondence with the error information.

Next, a method for extracting one error solve operation data (including URI) with the extracting part 1203 is briefly described. In a case where an authentication process is performed for allowing the user to activate the remote application 420, the operation data management unit 1200 can identify the user performing an operation if an error occurs by the operation.

Therefore, for example, in a case where the user inputs a command to execute a facsimile function without setting a destination, an error solve operation data for enabling a destination setting corresponding to the identified user can be extracted. The destination setting corresponding to the identified user may be, for example, setting a destination that is frequently used when the facsimile function is used by the identified user.

Hence, in addition to the effects attained by the first embodiment, the second embodiment enables error solve operation data (including URI) corresponding to a user to be extracted from multiple error solve operation data (including URI) corresponding to multiple solution procedures derived according to error information.

Thereby, because the number of operation buttons incorporated in the help/solve screen can be reduced, the operation workload of the user can be further reduced in a case where an error occurs.

### Third Embodiment

In the second embodiment, one error solve control data (including URI) corresponding to the user is extracted from multiple error solve control data (including URI) corresponding to multiple solution procedures. However, the method for extracting one error solve control data (including URI) is not limited to the method described in the second embodiment. Further, the number of error solve control data (including URI) to be extracted from the multiple error solve control data (including URI) is not limited to a single error solve control data (including URI).

For example, each of the multiple error solve control data (including URI) may be set with priority levels beforehand. Thereby, an error solve operation data (URI) having a priority level that is equal to or greater than a threshold set by the user can be extracted from the multiple error solve control data (including URI).

Accordingly, in a case where the remote application 420 is installed in a mobile terminal or the like that has a small operation panel, only one or more error solve operation data (including URI) having a high priority level can be set to be displayed on the operation panel. Further, in a case where the remote application 420 is installed in a PC (Personal Computer) or the like that has a large operation panel, one or more solve operation data (including URI) having a low priority level can be set to be displayed in the operation panel. That is, solve operation data can be displayed according to the operation environment of the user.

Alternatively, the number of solve operation data to be displayed may be set beforehand by the user. Thereby, error solve operation data having high priority are displayed within the number of solve operation data set by the user.

Accordingly, by extracting only the error solve operation data having a priority level satisfying a predetermined condition, a predetermined number of error solve operation data (including URI) are always displayed in a case where an error occurs. That is, a predetermined number of operation buttons are always displayed on the error/solve screen in a case where an error occurs.

Therefore, with the third embodiment, in a case of performing an operation for solving an error, operability for performing the operation can be improved.

### Fourth Embodiment

Although the operation data management unit 503 is constantly activated in the first-third embodiments, the present invention is not limited to these embodiments. For example, the operation data management unit 503 may be activated only at a predetermined timing designated by the user.

Accordingly, in a case where an error occurs, the user can arbitrarily switch between a mode for displaying the help screen and a mode for displaying the help/solve screen.

### Other Embodiments

Although each of the parts for implementing the help function (see FIG. 5) is provided in the main body unit 102 of the image process apparatus 100 in the first-fourth embodiments, the present invention is not limited to these embodiments. For example, each of the parts for implementing the help function may be provided in the operation unit 101 of the image process apparatus 100. Alternatively, a portion of the parts for implementing the help function may be provided in the operation unit 101 whereas another portion of the parts for implementing the help function may be provided in the main body unit 102.

Any of these embodiments may be used as long as a data process apparatus that includes a program for executing each of the parts for implementing the help function is provided in a given location inside the image process apparatus 100.

Further, although a help/solve screen is displayed in the operation panel 415 of the mobile terminal 110 in a case where an error occurs due to an operation performed on the mobile terminal 110 in the first-fourth embodiments, the present invention is not limited to these embodiments. For example, a help/solve screen may be displayed in the operation panel 215 of the operation unit 101 of the image process apparatus 100 in a case where an error occurs due to an operation performed on the operation unit 101.

The present invention is not limited to the specifically disclosed embodiments, and variations and modifications may be made without departing from the scope of the present invention.

The present application is based on and claims the benefit of priority Japanese Priority Application No. 2013-252223 filed on Dec. 5, 2013, with the Japanese Patent Office, the entire contents of which are hereby incorporated by reference.

What is claimed is:

1. A data process apparatus comprising:
a read-out unit configured to read out screen data according to an error that has occurred, the screen data including information pertaining to the error;
an obtaining unit configured to obtain a user interface component for receiving an operation for executing a solution procedure for solving the error; and
a generating unit configured to generate a screen to be displayed according to the error by incorporating the user interface component in the screen data.

2. The data process apparatus as claimed in claim 1, further comprising:
an extracting unit configured to extract a predetermined number of user interface components from a plurality of user interface components obtained by the obtaining unit,
wherein the generating unit is configured to incorporate the predetermined number of user interface components in the screen data.

3. The data process apparatus as claimed in claim 2, wherein the extracting unit is configured to extract a user interface component corresponding to a user that has performed an operation causing the error.

4. The data process apparatus as claimed in claim 2,
wherein a priority level is set beforehand to the user interface component, and
wherein the extracting unit extracts the user interface component having the priority that satisfies a condition set by the user.

5. The data process apparatus as claimed in claim 1, further comprising: a switching unit configured to switch the generating unit between a first mode and a second mode,
wherein the generating unit is configured to generate the screen to be displayed according to the error by incorporating the user interface component in the screen data when the generating unit is in the first mode, and
wherein the generating unit is further configured to generate the screen to be displayed according to the error without incorporating the user interface component in the screen data when the generating unit is in the second mode.

6. A data process method comprising the steps of:
reading out screen data according to an error that has occurred, the screen data including information pertaining to the error;
obtaining a user interface component for receiving an operation for executing a solution procedure for solving the error; and
generating a screen to be displayed according to the error by incorporating the user interface component in the screen data.

7. A data process system comprising:
first and second data process apparatuses,
wherein the first data process apparatus includes
a displaying unit configured to display a screen on which an operation is performed for controlling the second data process apparatus, and
a first transmission unit configured to transmit a request according to the operation performed on the screen, and
wherein the second data process apparatus includes
a read-out unit configured to read out screen data according to the request, the screen data including information pertaining to an error that has occurred,
an obtaining unit configured to obtain a user interface component for receiving an operation for executing a solution procedure for solving the error,
a generating unit configured to generate a help screen to be displayed according to the error by incorporating the user interface component in the screen data, and
a second transmission unit configured to transmit the help screen to the first data process apparatus,
wherein the displaying unit is further configured to display the help screen transmitted from the second transmission unit.
